(19) United States
(12) Patent Application Publication
(10) Pub. No.: US 2008/0275883 A1
(43) Pub. Date: Nov. 6, 2008

(54) Consolidated subscriber database for IMS network

(76) Inventors: Syed Reaz Ashraf, Sparta, NJ (US); Behzad Davachi Mottahed, Montclair, NJ (US)

Correspondence Address: MCCORMICK, PAULDING & HUBER LLP, 185 ASYLUM STREET, CITY PLACE II, HARTFORD, CT, 06103, US

(21) Appl. No.: 11/799,945

(22) Filed: May 3, 2007

(51) Int. Cl. G06F 17/00

(52) U.S. Cl. 707/10; 707/E17.032

(57) ABSTRACT

An IP multimedia subsystem (IMS) network includes a plurality of network elements that are interconnected for directly or indirectly communicating with one another. One of the network elements houses (or embodies) a consolidated subscriber database. The consolidate subscriber database is the only data storage entity in the IMS network for non-transitory storage of consolidated user data (that is, data relating to multiple user), for purposes of carrying out the core communication functions of the network. The user data is data relating to subscribers (e.g., end users) and subscriber services in the IMS network, such as user profile data and data relating to supplementary user services, e.g., call forwarding, call waiting, and the like. The consolidated database replaces the multiple database typically present in an IMS network, thereby lowering operational expenditures and simplifying data management operations.

### FIELD OF THE INVENTION

The present invention relates to communication systems and, more particularly, to data management systems in an IMS telecommunication network.

### BACKGROUND OF THE INVENTION

The IP Multimedia Subsystem (“IMS”) is a standardized “next generation” networking architecture for providing multimedia services in mobile/wireless and fixed/wire-line communication networks. The IMS uses the Internet protocol (IP) for packet-data communications generally, and voice over IP (VoIP) for voice communications, based on a 3GPP/3GPP2 standardized implementation of SIP (session initiation protocol). (SIP is a signaling protocol used for establishing sessions, such as a two-way telephone call or multi-party phone conference, in an IP network.) The IMS works with any packet switched network, both wire-line based and wireless, such as GPRS, UMTS, CDMA2000, and WiMAX. Legacy circuit-switched phone systems and similar networks (e.g., POTS, GSM) are supported through gateways. The IMS includes session control, connection control, and an application services framework along with subscriber and services data. It enables the use of new converged voice and data services, while facilitating the interoperability of these converged services between subscribers.

In an IMS-based network, as is generally the case with other communication networks, user terminals provide a means for users to communicate with one another over the network(s). Each terminal is an electronic device with hardware and/or software-based functionality for communicating over a network, and typically including user input/output means such as a keyboard and display. Examples include computer terminals, as well as wireless units such as mobile phones, wireless PDA's, wireless devices with high-speed data transfer capabilities, such as those compliant with “3-G” or “4-G” standards, “WiFi”-equipped computer terminals, and the like. When communications are initiated between terminals, e.g., a calling/caller terminal initiates communications with a called/“callee” terminal, the network attempts to open a communication channel between the two terminals according to various automatic signaling procedures. As part of this process, the network may need to access user data of one or both terminals, e.g., data relating to terminal identity and network location, billing information, and users preferences. Other ongoing network operations also require accessing user data. However, because user data is distributed among a number of different databases or other network elements based on the type of data, operations involving accessing and managing user data can be relatively complex and time consuming. Considering the large number of network elements that access and/or manage user data in an IMS network, and the frequency with which such operations are carried out, the distributed user data architecture results in substantial operational expenditures.

### SUMMARY OF THE INVENTION

An embodiment of the present invention relates to a consolidated subscriber database for an IP multimedia subsystem (IMS) network. The IMS network includes a plurality of network elements that are interconnected for carrying out communications with one another. By “network element,” it is meant telecommunications equipment, typically comprising a combination of hardware and software, that is addressable and manageable, and that primarily performs a core telecommunications service function of the IMS network. (As should be appreciated, this excludes end-user terminals peripheral to the IMS network.) One of the network elements houses (or is embodied by) a consolidated subscriber database. The consolidated subscriber database is the only data storage entity in the IMS network for the non-transitory storage of consolidated user data. The user data includes data relating to end user subscribers and end-user services in the IMS network, such as user profile data and data relating to supplementary user services, e.g., call forwarding, call waiting, and the like. “Consolidated” user data refers to user data relating to a plurality of end users/subscribers. By “non-transitory” storage of consolidated data, it is meant storing consolidated data for an indefinite time period (e.g., permanent or long-term storage), where the data is stored/utilized for purposes of carrying out the core communication functions of the IMS network.

In contrast to other IMS network configurations where user data is stored in a distributed manner across a number of different network elements, the consolidated database network architecture of the present invention reduces data management complexity, lowers the network operational expenditures associated with user data storage and exchange, and makes it easier to maintain user profiles and associated features.

In another embodiment, the consolidated subscriber database is part of a home subscriber server (“HSS”), which may itself be part of a home location register (“HLR”). The other elements in the IMS network are configured to access the HSS for storing and/or obtaining user-related data from the consolidated database.

In another embodiment, one of the network elements is a feature server. The feature server, which would normally store user data in a distributed architecture, instead stores and retrieves user data from the consolidated database on the HSS. This eliminates the need for the HSS and feature server to coordinate or share user data storage.

In another embodiment, one or more of the IMS network elements include a user-data forwarding module. (By “module,” it is meant a hardware/software subsystem implemented on or as part of a network element.) The user-data forwarding module is configured to (i) forward user data to the consolidated subscriber database, if it receives user data over the IMS network, and/or (ii) provide location information of the subscriber database to network elements that request the transfer of user data. The forwarding module compensates for cases where a legacy network element is not configured for accessing the consolidated database. Thus, for a network element that includes the forwarding module, if a legacy network element attempts to transfer user data to that network element, the forwarding module forwards the user data to the consolidated database. Alternatively, the forwarding module may reject the transmitted data, and inform the legacy network element of the network location of the consolidated database, for re-transmission of the data. Similarly, if the legacy network element sends a request for user data, e.g., in an expectation that the network element will respond by transmitting the user data, the forwarding module instead sends the network location of the consolidated database to the legacy network element. The legacy network element subsequently sends the request for user data to the consolidated database based on the received network location information.

### BRIEF DESCRIPTION OF THE DRAWINGS

The present invention will be better understood from reading the following description of non-limiting embodiments, with reference to the attached drawings, wherein below:

FIG. 1 is a schematic diagram of an IMS (IP multimedia subsystem) network with consolidated subscriber database, according to an embodiment of the present invention;

FIG. 2 is a schematic diagram of an optional user-data forwarding module portion of the IMS network architecture; and

FIG. 3 is a flowchart showing database operation.

### DETAILED DESCRIPTION

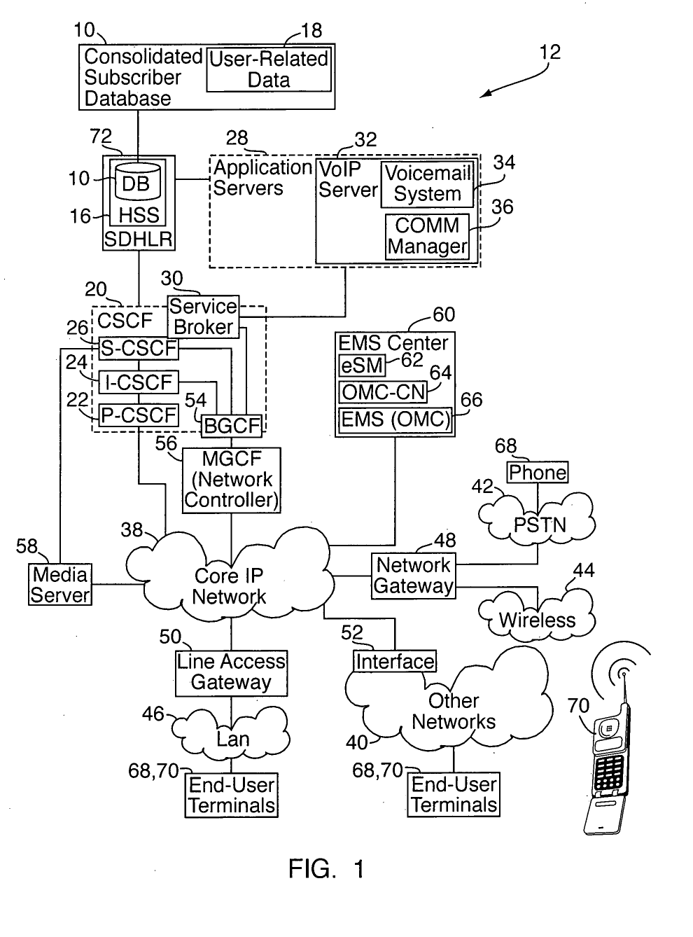

With reference to FIGS. 1-3, a consolidated subscriber database 10 is implemented on or as part of an IMS (IP multimedia subsystem) communication network 12. The IMS network 12 includes a plurality of network elements 14 that are interconnected for carrying out communications over the IMS network 12. As noted above, “network element” refers to telecommunications equipment, typically comprising a combination of hardware and software, that is addressable and manageable, and that primarily performs a core telecommunications service function of the IMS network. The consolidated subscriber database 10 is housed in one of the network elements, e.g., as part of a home subscriber server (“HSS”) 16. The consolidated subscriber database 10 is the only data storage entity in the IMS network 12 for non-transitory storage of consolidated user data 18. The user data includes data relating to end users and end user services in the IMS network 12, such as user profile data and data relating to supplementary user services, e.g., call forwarding, call waiting, and the like. “Consolidated” user data refers to user data relating to multiple end user subscribers. By “non-transitory” storage of consolidated data, it is meant storing consolidated data for an indefinite time period (e.g., permanent or long-term storage), where the data is stored/utilized for purposes of carrying out the core communication functions of the IMS network. Thus, although it may be the case that another network element stores the data of an individual end user, or that other network elements store data relating to multiple users on a transitory basis and/or for purposes unrelated to core network communications (e.g., billing), the consolidated database 10 is the only data storage element in the IMS network for non-transitory storage of data relating to multiple users, where the data is stored and used for carrying out the communication functions of the IMS network.

As the term is used herein according to its customary and normal meaning, the IMS network 12 is an IP multimedia and telephony core network as generally defined by 3GPP and 3GPP2 standards and organizations based on IETF Internet protocols. FIG. 1 illustrates, as a simplified example, the typical components that comprise an IMS network, and how they relate to one another and to the consolidated subscriber database 10. The IMS control architecture includes the HSS (home subscriber server) 16 and a call session control function (“CSCF”) 20, and may generally be divided into a services/application layer, an IMS layer, and a transport layer. The HSS 16 in this case is the central repository of all subscriber- or user-specific data 18, including user authorizations, service permissions, service profiles, and preferences. The HSS 16 integrates several functions/elements, including the consolidated database 10, authentication and authorization, mobile authentication server, and the like. The CSCF 20 carries out the primary SIP signaling functions in the network 12. The CSCF 20 includes several types of SIP servers, including a proxy-CSCF (“P-CSCF”) server 22 (which is the first point of contact for device and controls authentication), an interrogating-CSCF (“I-CSCF”) server 24 (which is the entry point of all SIP messages), and a serving-CSCF (“S-CSCF”) server 26, which manages session control functions. Application servers 28 host and execute services, and interface with the CSCF 20 using SIP, typically through a service broker function 30. This allows third party providers to easily integrate and deploy their value added services on the IMS infrastructure. Examples include caller ID-related services, call waiting, call holding, push to talk, conference call servers, voicemail, instant messaging, call blocking, and call forwarding.

One of the application servers 28 may be a VoIP application server 32, such as the Alcatel-Lucent FS5000 (Feature Server 5000). The VoIP server 32 is a VoIP service delivery platform with IMS functionality that supports a set of enterprise and consumer voice capabilities, including a voicemail system 34 and a communication manager 36 for call waiting, caller ID, conference calling, and the like.

The CSCF 20 is connected to a broadband IP network 38, which acts as the core of the IMS network 12 for interconnecting and/or interfacing with other networks 40 and with other network elements that operate at the IMS transport layer. Thus, the IMS network 12 may include and/or be connected with a number of IP-based and other networks such as the Internet, DSL networks, public switched telephone networks (“PSTN”) 42 and other wire-line networks, wireless networks 44 such as those using CDMA, GSM, IEEE 802.11x, and/or UMTS communications or the like, and local area networks (“LAN”) 46. Typically, the IMS core network 38 is interfaced with other networks 40, 42, 44, 46 by way of a network gateway 48, line access gateway 50, or other hardware/software interface 52.

In the example shown in FIG. 1, portions of the CSCF 20 are connected to the core IP network 38 by way of one or more gateway elements, such as a breakout gateway control function (“BGCF”) 54 and a media gateway controller function (“MGCF”) or other network controller 56. The BGCF 54 is an SIP server that includes routing functionality based on telephone numbers. The MGCF 56 (e.g., an Alcatel-Lucent NC network controller) provides a media gateway control (MGC) function for VoIP purposes, thereby providing the centralized call control function for the multiple network gateways 48, 50, 52. Additionally, the MGCF 56 acts as a bridge between third generation converged multi-service networks and legacy circuit switched networks. For example, the MGCF 56 may carry out the call processing functions necessary to translate between SIP-based wireline or wireless calls in the IMS network and ISUP calls in a PSTN 42.

The IMS network 12 may also include a media server 58, such as the Alcatel-Lucent Enhanced Media Resource Server™ (“eMRS”), and an EMS center 60. The media server 58 supports SIP call control of RTP (real time packet) sessions, is compatible with circuit switched networks in addition to SIP based packet switched networks for both wire line and wireless networks, and may provide enhanced media-control services such as announcement players, tone generators, conferencing, text-to-speech synthesizers, and the like. The EMS (element management system) center 60 may include an enhanced services manager (“eSM”) 62, an operations and maintenance center—core network (“OMC-CN”) 64 for core network management, and an element management system (“EMS”) and/or operations and maintenance center (“OMC”) 66. The EMS 66 manages one or more of a specific type of network elements. The eSM 62 provides data processing and management functions, and provisions multiple services across multiple regions and multiple networks.

For communicating over the IMS network 12, subscribers are provided with end-user communication terminals 68, 70. The terminals 68, 70 are electronic devices capable of communicating with one another over the network(s) 12, 42, 44, 46, and may include, for example, computer terminals, wire-line connected communication devices such as conventional telephones and enhanced/multimedia-capable telephones 68, and/or wireless units 70 such as mobile phones, wireless PDA's, wireless devices with high-speed data transfer capabilities, such as those compliant with “3-G” or “4-G” standards, “WiFi”-equipped computer terminals, and the like. The terminals 68, 70 communicate with one another over the networks in a standard manner, depending on the particular networks used and the particular type of terminals. For example, in the case of wireless units 70 and a wireless network 44, the network 44 may include one or more fixed base stations (not shown) having various transceivers and antennae for wireless, radio-frequency (RF) communications with the wireless units over one or more RF channels, in a manner based on the wireless communication method and protocol used.

For simplicity of illustration, some intermediate network elements such as access gateways and server nodes are not shown. Further explanation regarding the operation of an IMS network is available in the literature, and is known to those skilled in the art.

As noted above, the consolidated subscriber database 10 is housed in (or embodied as) an IMS network element 14. In other words, the database 10 may be part of another network element that performs other functions, or it may be a separate network element, that is, separately addressable and manageable network equipment apart from other elements. (Thus, when the database is characterized herein as being part of, or housed in, a network element, this includes both possibilities.) For ease of implementation, however, the consolidated subscriber database 10 will typically be implemented on network equipment already including or configured to include a database, such as the HSS 16.

As another example, as shown in FIG. 1, the database 10 and/or HSS 16 may be part of a home location register, such as an Alcatel-Lucent super-distributed home location register (“SDHLR”) 72. The SDHLR maintains critical information such as subscriber profiles and user location, and manages tasks such as user authentication for both voice and data services. It also enables a single sign-on for all services and applications, supports simple provisioning of new services, and ensures that subscribers always have access to all of their services when they roam outside of their home network. The SDHLR enables the establishment of unified customer profiles and centralized subscriber authentication—independent of the access method used—and therefore can support global roaming across multiple network types including third-generation CDMA2000) and UMTS/W-CDMA, as well as WiFi and wireline networks. It also provides the HSS functionality for the IMS network, and can provide HLR functionality in new and legacy networks.

The consolidated subscriber database 10 is the only data storage entity in the IMS network 12 for the non-transitory storage of consolidated user data 18. Thus, the user data that would otherwise be stored on other network elements in a distributed architecture is instead consolidated in the subscriber database 10. For any network communication functions that require the storage or accessing of user data, the network elements are configured to access the consolidated subscriber database 10. This may be done on a direct or indirect basis. In regards to the former, the network element in question communicates with the database 10 directly, or with the network element that houses the database, for storing or retrieving data. In regards to the latter, network elements communicate with a designated network element for obtaining or storing user data, which in turn communicates with the subscriber database 10 for carrying out data exchange operations. The particular manner in which network elements exchange data with the subscriber database 10 will typically depend on the particular components and configuration of the IMS network 12 as implemented, and may vary from network element to network element.

FIG. 3 summarizes the operation of the subscriber database 10 in simplified form, as it relates to external network elements. (Database operation is explained herein for the case of the database being a separate network element. Operation is similar in cases where the database is housed in another network element.) At Step 100, the database 10 is in a standby mode. (“Standby” refers to the database waiting for requests for data retrieval or storage from other network elements, not that the database is necessarily idle.) If the database 10 receives user data for storage, at Step 102 the database stores the received user data in its memory/storage, e.g., hard disk storage, tape storage, RAM/ROM storage, optical storage, or the like. The user data is stored according to what is contained in the data and/or in regards to what the data relates to, and according to the internal logic and structure of the database. For example, if the user data relates to a particular user/subscriber, then the data will typically be stored in relation or connection to other data associated with the user. After the data is stored, the database returns to its standby mode at Step 100. If the database 10 receives a request for user data from a network element, at Step 104 the database 10 retrieves the requested data from its memory/storage. This is done in a standard manner according to the configuration of the database and the nature of the data requested. At Step 106, the database 10 transmits the requested user data to the requesting network element. Subsequently, the database 10 returns to the standby mode at Step 100.

In regards to its internal operation and structure for storing and retrieving data, the consolidated subscriber database 10 is configured in a standard manner, according to standard database design principles. As such, further detail is not provided herein.

The user data 18 includes data relating to end user subscribers and end user services in the IMS network 12, such as user profile data and data relating to supplementary user services, e.g., call forwarding, call waiting, and the like. Since the database 10 acts as the sole element in the IMS network for storing consolidated user data for purposes of core network communication functions, none of the other network elements 14 are configured to perform such a function. However, it may be the case that one or more network elements (other than the consolidated database) store data in a limited or unrelated manner, for other purposes. For example, certain elements may store user data on a transitory basis, meaning that the data resides in memory only long enough for performing a particular communication operation, and not for purposes of long-term storage, that is, storage for an indefinite length of time. Also, other elements may store user data for an indefinite time period, but for purposes unrelated to carrying out communications over the IMS network, e.g., billing. Further, since the consolidated subscriber database 10 relates to core communication operations, it is does not encompass or require the modification of data structures on end-user terminals 68, 70, which are not considered network elements as defined herein. That is to say, it may be the case that end-user terminals store user-related data for multiple users (e.g., contact lists), but this data is not part of the internally stored data in the IMS network, which is used for internal network purposes according to the communication protocols in place on the network.

For implementing the consolidated subscriber database architecture described above, the IMS network 12 is outfitted with the database 10, which is configured for storing and retrieving all the types and categories of user data utilized in the IMS network. (As noted above, the internal operation of the database 10 follows standard database design principles.) This may be done by adding the database to the network as part of a new network element, or it may be implemented by modifying an existing database in the IMS network 12. For example, an IMS network HSS 16 will typically include a database and data management functionality, which can be modified using standard methods for implementing the consolidated database 10. If the IMS network is newly implemented from the “ground up,” the other elements in the network are simply configured to directly or indirectly access the consolidated database 10 for user data retrieval and storage operations, and do not themselves store consolidated user data. If the consolidated database architecture is implemented on an existing IMS network, then existing network elements are reconfigured in a standard manner, e.g., reprogramming or programming updates, to access the consolidated database 10 for user data retrieval and storage operations. Any existing databases are disabled or used for other purposes.

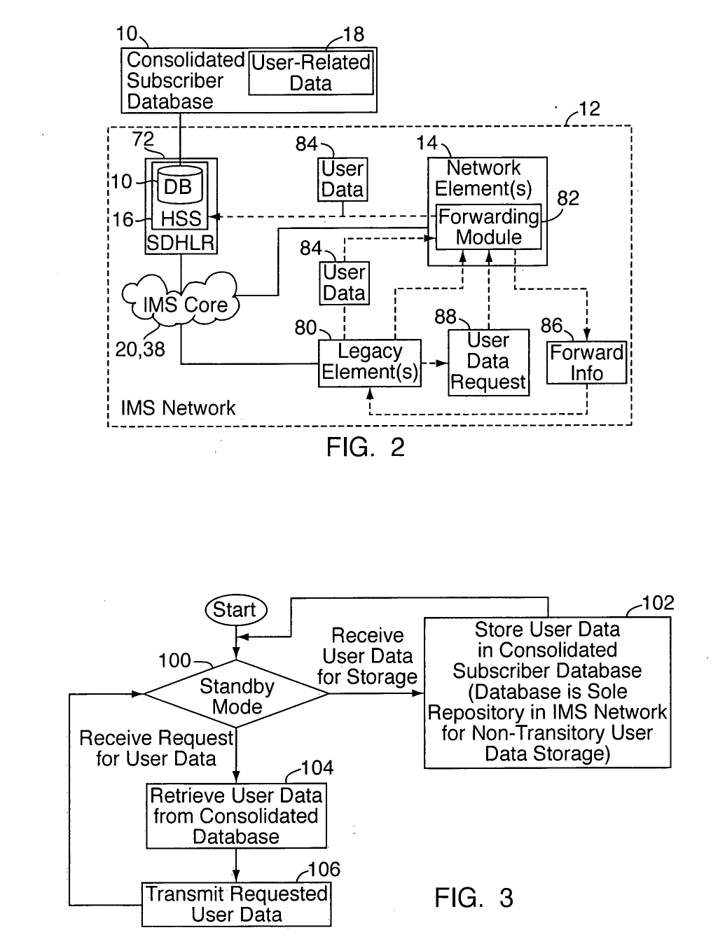

If the consolidated subscriber database 10 is added to an IMS network where it is not possible or practicable to modify certain network elements for accessing the database 10, or for situations where there may be legacy network elements 80 accessing user data, one or more of the network elements 14 may be provided with a user-data forwarding module 82. An example of this is shown in FIG. 2. As noted above, “module” refers to a hardware/software subsystem implemented on or as part of a network element. The user-data forwarding module 82 is outfitted on network entities that may expect to receive user data for storage, and/or that may expect to receive requests for providing stored user data. For example, the forwarding module 82 could be outfitted on a feature server 32, which in a distributed architecture would normally store consolidated user data. Thus, when a legacy network element 80 transmits user data 84 to a network element 14 (which has the forwarding module 82 installed thereon), the forwarding module 82 causes the network element 14 to redirect the user data 84 to the consolidated database 10. Alternatively, the forwarding module 82 rejects the data 84, and instead transmits forwarding information 86 to the legacy element 80, which informs the legacy element 80 of the network location of the database 10 for sending user data for storage. When a legacy element 80 sends a data request 88 to the network element 14, the forwarding module 82 may either redirect the data request 86 to the consolidated database 10, or it may reject the data request and instead transmit the forwarding information 86 back to the legacy element 80.

The forwarding module 82 compensates for cases where a legacy network element 80 is not configured for accessing the consolidated database 10. Thus, for a network element 14 that includes the forwarding module 82, if a legacy element 80 attempts to transfer user data 84 to that network element, the forwarding module 82 forwards the user data 84 to the consolidated database 10. Alternatively, the forwarding module 82 may reject the transmitted data 84, and inform the legacy network element 80 of the network location of the consolidated database 10, for re-transmission of the data 84. Similarly, if the legacy network element 80 sends a request 88 for user data, e.g., in an expectation that the network element 14 will respond by transmitting the user data, the forwarding module 82 instead sends the network location of the consolidated database to the legacy network element. The legacy network element subsequently sends the request for user data to the consolidated database based on the received network location information.

Depending on the particular characteristics of the IMS network, it may not be necessary to utilize forwarding modules. For example, it may be a simple matter to re-configured the network elements for accessing the consolidated database, or the IMS network may be configured for all network elements to access a directory-like function/element for obtaining user data, wherein the directory function is reconfigured to direct inquiries to the consolidated database instead of to multiple databases, as in the case of a distributed user-data storage network architecture.

Since certain changes may be made in the above-described consolidated subscriber database for IMS network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. An IP multimedia subsystem (IMS) network comprising:
a first IMS network element having a subscriber database; and
a plurality of second IMS network elements, said first and second IMS network elements being interconnected for communications with one another;
wherein the subscriber database is the only database in the IMS network for non-transitory storage of consolidated user data.

2. The network of claim 1, wherein the second network elements are configured to access the first IMS network element for obtaining and/or storing user data.

3. The network of claim 2, wherein the first network element is an IMS network home subscriber server.

4. The network of claim 3, wherein the user data stored in the subscriber database comprises user profiles and data relating to supplementary user services in the IMS network.

5. The network of claim 2, wherein the user data comprises user profiles and data relating to supplementary user services in the IMS network.

6. The network of claim 2, wherein at least one of the second IMS network elements comprises a network feature server for implementing call-related features in the IMS network, said feature server lacking a database for storage of user data.

7. The network of claim 6, wherein the first network element is an IMS network home subscriber server.

8. The network of claim 7, wherein the user data stored in the subscriber database comprises user profiles and data relating to supplementary user services in the IMS network.

9. The network of claim 2, wherein at least one of said second IMS network elements includes a user-data forwarding module, said module being configured to (i) forward, to the subscriber database, user data received from any of the other second network elements, and (ii) upon receiving requests for user data from any of the other second network elements, provide location information of the subscriber database to said other second network elements.

10. The network of claim 9, wherein the first network element is an IMS network home subscriber server, and wherein the second network element that includes the user-data forwarding module is a network feature server for implementing call-related features in the IMS network.

11. The network of claim 2, further comprising:
a user-data forwarding module interfaced with a designated one of said second network elements, wherein the module is configured to (i) forward received user data to the first network element, and (ii) provide location information of the subscriber database upon the designated second network element receiving a request for user data.

12. The network of claim 11, wherein the first network element is an IMS network home subscriber server, and wherein the designated second network element is a network feature server for implementing call-related features in the IMS network.

13. An IP multimedia subsystem (IMS) network comprising:
a primary IMS network element having a subscriber database; and
a plurality of secondary IMS network elements directly or indirectly connected to the primary IMS network element;
wherein the subscriber database is the only database in the IMS network for non-transitory storage of consolidated user-related information, said information including user profiles and data relating to supplementary user services in the IMS network; and
wherein the secondary network elements are configured to access the primary network element for storage and/or retrieval of user-related information from the subscriber database.

14. The network of claim 13, wherein the primary network element is an IMS network home subscriber server, and wherein at least one of the secondary IMS network elements is a network feature server for implementing call-related features in the IMS network, said feature server lacking a database for storage of user data.

15. The network of claim 14, further comprising:
a user-data forwarding module interfaced with the feature server, wherein the module is configured to (i) forward, to the home subscriber server, user data received by the feature server, and (ii) provide location information of the subscriber database upon one of the other secondary network elements requesting user data from the feature server.

16. The network of claim 13, further comprising:
a user-data forwarding module interfaced with a first of said secondary network elements, wherein the module is configured to (i) forward, to the subscriber database, user data received by the first secondary network element, and (ii) provide location information of the subscriber database upon one of the other secondary network elements requesting user data from the first secondary network element.

17. A method for managing data in an IP multimedia subsystem (IMS) network, said method comprising the steps of:
storing user data in a subscriber database; and
transmitting the user data to a network element based on a received request for the user data;
wherein the subscriber database is the only storage element in the IMS network for non-transitory storage of consolidated user data.

18. The method of claim 17, further comprising, for each element in the IMS network that generates user data to be stored in a consolidated manner for IMS network operations, transmitting the user data from each said element to the subscriber database for storage therein.

19. The method of claim 18, further comprising:
receiving a request for user data at a network element other than a network element housing the database; and
transmitting forwarding information to the network element that transmitted said request, said forwarding information relating to a network location of the database for transfer of user data thereto.

20. The method of claim 18, further comprising:
receiving user data at a first network element from a second network element, said first and second network elements being network elements other than a network element housing the database; and
forwarding the received user data from the first network element to the network element housing the database.
